(19) United States
(12) Patent Application Publication
(10) Pub. No.: US 2022/0106837 A1
(43) Pub. Date: Apr. 7, 2022

(54) Ladder Assembly

(71) Applicant: Ronald Giery, Redondo Beach, CA (US)

(72) Inventor: Ronald Giery, Redondo Beach, CA (US)

(21) Appl. No.: 17/492,277

(22) Filed: Oct. 1, 2021

Related U.S. Application Data
(60) Provisional application No. 63/086,342, filed on Oct. 1, 2020.

(51) Int. Cl. E06C 7/44; E06C 1/20

(52) U.S. Cl. CPC E06C 7/44; E06C 1/20

(57) ABSTRACT

A ladder assembly having a front frame having a first pair of spatially disposed legs, a plurality of rungs extending between the first pair of legs, and a pivot bracket mounted at the top of the front frame, a rear frame having a second pair of spatially disposed legs, one or more rungs extending between the second pair of legs, and a fixed bracket mounted at the top of the rear frame, wherein the pivot bracket is attached to the fixed bracket via a single point pivot bracket system configured to pivotally connect the front frame and the rear frame, a folding bracket system configured to keep a correct angle between the front frame and the rear frame, thereby allowing the rotational movement of the legs.

### CROSS-REFERENCE TO RELATED APPLICATIONS

This application claims the benefit of U.S. Provisional Patent Application Ser. No. 63/086,342 filed Oct. 1, 2021, entitled Ladder Assembly, the entire contents of which are incorporated by reference herein for all purposes.

### FIELD OF THE INVENTION

The present invention generally relates to stepping devices. More specifically, the present invention relates to a ladder assembly and attachable component configured to provide stability and allow all four legs of the ladder to maintain contact with the surface regardless of the surface irregularities, thereby providing improved safety to the user on the ladder.

### BACKGROUND

A ladder is a framework of two long structural members connected at regular intervals by parallel rungs for climbing or descending. The ladder assists workers by allowing them to work at elevated positions. The conventional ladder has a substantially A-shaped frame profile and comprises a plurality of vertical posts that are connected by cross-braces and which may be stacked on top of each other to permit workmen to work walls, ceilings, and the like.

Existing A-frame ladders are used on a flat service to be usable. Any unevenness of the surface causes one of the legs to lose contact with the surface. This lack of contact results in an unstable condition and allows for movement of the ladder in a lateral motion. This motion could cause the user to shift their center of gravity, unexpectedly, and the resulting uncontrolled movement could cause the ladder to fall over, kick out, or the user to lose balance and fall. Ladder falls are the leading cause of falls on commercial job sites.

Current statistics estimate that, as it relates to ladder falls, about 21.5% of accidents occur due to foot miss or slippage of workers. About 5-5.8% of accidents occur due to ladder damage and struck by any other objects. In addition, about 7.4% of accidents are due to the loss of balance by the workers and 3.3% due to other reasons. About, 2.5% of accidents are due to the movement of surfaces while using the ladder in uneven surfaces. Specifically, about 53.7% of ladder accidents occur due to the movement of ladders.

Ladder falls are the leading cause of falls in the home environment. Ladder falls account for hundreds of deaths and thousands of hospital emergency visits per year in the USA. Although fall-related injuries occur throughout the year, few studies have analyzed seasonal patterns, and none have examined the extent of such injuries associated with holiday decorating. In an estimation, about 17,465 persons were treated in U.S. hospital emergency departments (EDs) for holiday-decorating-related falls. Approximately 62% of those injured were aged 20-49 years and approximately 43% of injuries were caused by falls from ladders. Further, about 40% of males are injured more likely than females. Therefore, the prevention strategies should focus on raising awareness about falls and promoting safety practices during the holiday season.

In a retrospective study, structured telephone interviews were conducted to identify the circumstances of the fall, where it is found that most individuals who fell did not have anybody else for assistance. It pinpointed incorrect ladder placement and excessive reaching as the most common reasons for such falls. Nearly 70% of ladder falls in those aged 46-65 years and 90% of those aged above 66 years took place at home, thus reinforcing the idea that the aging population is especially vulnerable because they may not have anybody else for assistance.

Especially, the fall victims are older, more unstable individuals, since their injuries tend to be more severe than those suffered by their younger counterparts. But people of all ages, including kids, are exposed to the perils of preparing for the season. A governmental agency that seeks to safeguard people from consumer-product related risks states that about 200 people a day suffer decoration-related injuries. Further, in an estimation, about 13,000 people were treated in emergency rooms around the country for injuries tied to holiday lights, Christmas trees, ornaments, and other decorations, according to the CPSC.

Further, a study published in September in the journal Injury found that, in the worst cases, falls while installing Christmas lights could be life-altering, leaving individuals with traumatic brain injuries and the inability to live independently. These falls can even be deadly. Older people are particularly vulnerable after falling from ladders. Although they fell from lower heights, the elderly sustained different and more severe injury patterns. Ladder safety education should be particularly tailored to the elderly.

In light of all the above-mentioned drawbacks, there is a need for a ladder and a ladder component attachable to a ladder to provide stability and allow all four legs of the ladder to maintain contact with the surface regardless of the surface irregularities. Also, there is a need for a solution to provide improved safety to the user on the ladder.

### SUMMARY OF THE INVENTION

The present invention generally discloses ladder assemblies and components attachable to a ladder. Further, the present invention discloses a ladder assembly and component configured to provide stability and allow all four legs of the ladder to maintain contact with the surface regardless of the surface irregularities, thereby providing improved safety to the user on the ladder.

In one embodiment, the ladder is configured to provide stability and improved safety to a user/worker. The ladder comprises a front frame or a first frame and a rear frame or a second frame. In one embodiment, the front frame comprises a first pair of leg members or a first pair of legs and a plurality of rungs/steps extending between the first pair of legs. The front frame further comprises a pivot bracket mounted at the top of the front frame. The rear frame comprises a second pair of leg members or a second pair of legs and one or more rungs/steps extending between the second pair of legs. The rear frame further comprises a fixed bracket mounted at the top of the rear frame.

In one embodiment, the pivot bracket is configured to pivotally connect to the pair of legs at a leg pivot point thereby enabling movement independently of one another. In one embodiment, the pair of legs are pivotally mounted for movement independently of one another using the single point pivot bracket system. The independent movement of the pair of legs allows to adjust the surface irregularities, again, independent of the other set of legs.

In one embodiment, the pivot bracket is connected to the fixed bracket via a single point pivot bracket system configured to pivotally connect the front frame and the rear frame. In one embodiment, the legs are connected at the top of the frames via the single point pivot bracket system. In one embodiment, the single point pivot bracket system is configured to allow the pair of legs for detaching, thereby allowing the pair of legs to independently move in relation to one another.

In one embodiment, the ladder further comprises a folding bracket system or collapsible bracket system. In one embodiment, the folding bracket system is configured to maintain an optimal angle between the front frame and the rear frame thereby allowing the rotational movement of both pairs of legs and keeping them grounded. In one embodiment, both pairs of legs of the ladder are configured to lock together using the folding bracket system or collapsible bracket system, in which the plurality of rungs, the pivot brackets, and the set of brackets of the folding bracket system are nested within the frame and co-planar therewith for storage of the ladder.

In one embodiment, the folding bracket system determines the distance between both pairs of legs and allow to move apart from each other to allow the legs to rotate to the correct angle to keep the feet grounded. The folding bracket system must also be engineered to collapse and allow both pairs of legs to come together, thereby reducing the space required to move and store the ladder. In one embodiment, the folding bracket system allows the rotational movement of the independent set of legs.

In one embodiment, a ladder assembly is provided having a front frame having a first pair of spatially disposed legs and a plurality of rungs extending between the first pair of legs, a rear frame having a second pair of spatially disposed legs, a pivot bracket system coupled to the front and rear frame, wherein the pivot bracket system is configured to allow the legs to shift or pivot, wherein the pivot bracket system comprises, a pivot bracket attached to one of the front frame or rear frame, a fixed bracket attached to the other of the front frame or rear frame, a bearing coupled to the pivot bracket and the fixed bracket, wherein the bearing is configured to provide a pivot point for rotational motion of the pivot bracket and to pivotally connect the front frame and the rear frame, wherein the pivot bracket system is configured to allow the ladder legs to settle on an uneven surface based on the rotational motion provided by the pivot bracket.

In an embodiment, a modular ladder leveling device, is provided having a stationary bracket coupled to both legs of a ladder, wherein the stationary bracket has a hollow interior, an interior pivot bracket nested in the hollow interior of the stationary bracket, a pivot pin coupled to the stationary bracket and the interior pivot bracket, wherein the pivot pin provides rotational motion about the pivot pin such that when the ladder is placed on an uneven surface the legs settle on a surface, a lock integral with the stationary bracket and interior pivot bracket, wherein the lock is configured to lock the pivot bracket in place when the ladder legs settle on the surface.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of a ladder assembly in one embodiment of the present invention.

FIG. 2 a side view of the ladder in one embodiment of the present invention.

FIG. 3 shows an enlarged view of a single point pivot bracket system in one embodiment of the present invention.

FIG. 4 shows an enlarged top perspective view of the ladder in one embodiment of the present invention.

FIG. 5 also shows an enlarged top perspective view of the ladder in one embodiment of the present invention.

FIG. 6 shows a perspective view of a single point pivot bracket system of the ladder in one embodiment of the present invention.

FIG. 7 shows a perspective view of the pair of legs or rails of the ladder in a folded position or a locked position in one embodiment of the present invention.

FIG. 8 shows a perspective view of the ladder in an open position or unfold position in one embodiment of the present invention.

FIG. 9 shows perspective views of a folding bracket system of the ladder in one embodiment of the present invention.

FIG. 10 also shows perspective views of a folding bracket system of the ladder in one embodiment of the present invention.

FIG. 11 shows a perspective view of the ladder in a closed position in one embodiment of the present invention.

FIG. 12 shows a perspective view of the pair of legs or rails of the ladder provided with non-slip feet in one embodiment of the present invention.

FIG. 13A shows a perspective view of the single point pivot bracket system broken into two pieces in embodiment of the present invention.

FIG. 13B also shows a perspective view of the single point pivot bracket system broken into two pieces in embodiment of the present invention in one embodiment of the present invention.

FIG. 14 shows a front view of a stabilizing component attachable to a ladder in one embodiment of the present invention.

FIG. 15 shows a front view of a stabilizing component attachable to a ladder in use one embodiment of the present invention.

FIG. 16 shows a partially exploded view of a stabilizing component attachable to a ladder in one embodiment of the present invention.

### DETAILED DESCRIPTION OF EMBODIMENTS

The present invention is best understood by reference to the detailed figures and description set forth herein.

Embodiments of the system are discussed below with reference to the examples. However, those skilled in the art will readily appreciate that the detailed description given herein with respect to these examples is for explanatory purposes as the system extends beyond these limited embodiments. For example, it should be appreciated that those skilled in the art will, in light of the teachings of the present system, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the system that are too numerous to be listed but that all fit within the scope of the system. Also, singular words should be read as plural and vice versa and masculine as feminine and vice versa, where appropriate, and alternative embodiments do not necessarily imply that the two are mutually exclusive.

It is to be further understood that the present system is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present system. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this system belongs. Preferred methods, techniques, devices, and materials are described, although any methods, techniques, devices, or materials similar or equivalent to those described herein may be used in the practice or testing of the present system.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

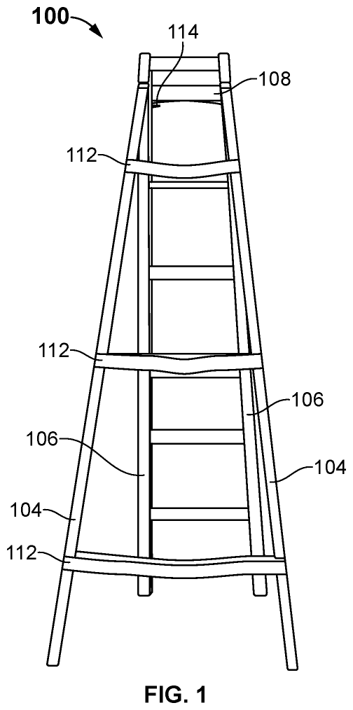

Referring to FIG. 1, a back perspective view of a ladder assembly (hereinafter referred as ladder) 100, according to one embodiment of the present invention is shown. The ladder 100, via single point pivot bracket system 108, is configured to allow the legs to shift or pivot the legs so they rest safely on the ground to provide stability and improved safety to a user/worker. It is noted that while the pivot bracket 108 is positioned on the top portion of the ladder, it may be positioned in a middle section or lower portion of the ladder.

The ladder 100 comprises a front frame (legs 106) and a rear frame (legs 104). In one embodiment, the front frame a plurality of rungs/steps 112 extending between the first pair of legs 106. In one embodiment, the front frame and back frame are connected via single point pivot bracket system 108 mounted at the top of the front frame.

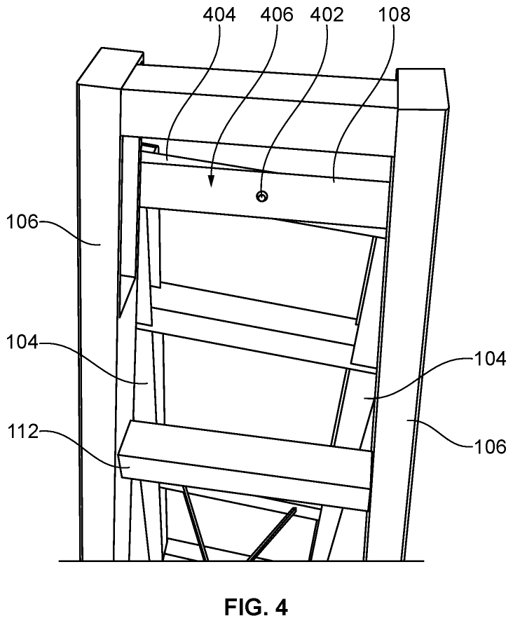

In one embodiment, the rear frame comprises a second pair of rails 104 and one or more rungs/steps 112 extending between the second pair of rails 104. The rear frame further comprises a fixed bracket 406 (as shown in FIG. 4) mounted at the top of the rear frame to which the pivot bracket 404 is attached. In one embodiment, the pivot bracket 404 is connected to the fixed bracket 406 to form the single point pivot bracket system 108 configured to pivotally connect the front frame and the rear frame.

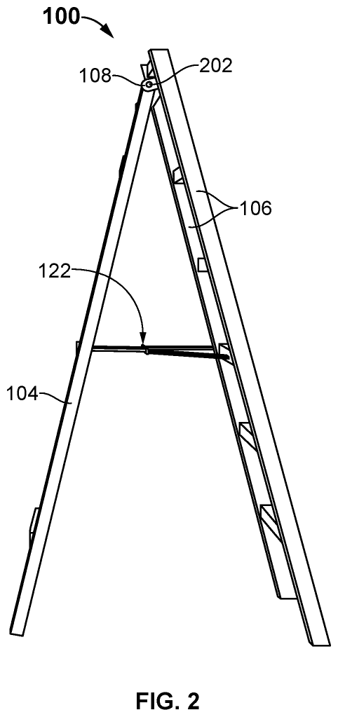

Referring to FIG. 2, a side view of the ladder 100 according to one embodiment of the present invention is shown. The ladder comprises the front frame 204 and the rear frame 206. In one embodiment, the front frame 204 comprises the first pair of legs 106 and the rear frame 206 comprises the second pair of legs 104. In one embodiment, the frames are connected at the top portion of each via the single point pivot bracket system 108. A bearing 202 is shown integral with the single point pivot bracket system 108. The bearing 202 is configured to allow movement and rotation at the single point bracket system so that it can be folded for storage. As can be seen, the single point pivot bracket system 108 is coupled to the front frame at a position that is slightly lower than the top of the front frame. The rear frame 206 is shorter than the front frame, and the single point pivot bracket system 108 attaches to the top of the rear frame 206.

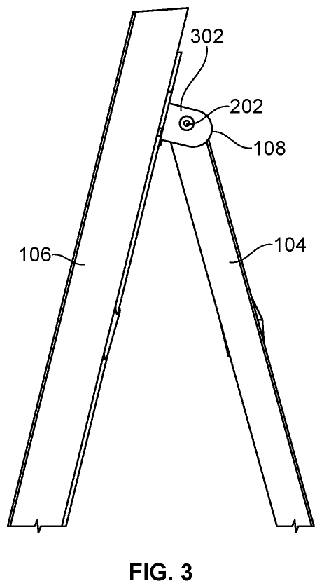

Referring now to FIG. 3, an enlarged side view of the single point pivot bracket system 108 connecting the frames 204 and 206 (at their respective legs 104 and 106) according to one embodiment of the present invention is shown. In one embodiment, the single point pivot bracket system 108 allows for the frames 204 and 206 (at their respective legs 104 and 106) to collapse for storage. The side cap 302 of the single point pivot bracket system 108 connects the frames 104 and 106 and bearing 202 allows the ladder to collapse and fold into storage position.

Referring now to FIG. 4, an enlarged top perspective view of the ladder 100 according to one embodiment of the present invention is shown. For purposes of orientation, the front frame and the rear frame are shown together with the first pair of legs 106 and a plurality of rungs 112 extending between the first pair of legs 106, the second pair of legs 104 and one or stabilizers extend between the second pair of legs 104. In one embodiment, the legs (104 and 106) are connected at or near the top of the front and rear frames via the single point pivot bracket system 108. The pivot bracket 108 comprises a fixed bracket 406 rotatably secured to a pivot bracket 404. In one embodiment, the pivot bracket 404 is connected to the fixed bracket 406 to form the single point pivot bracket system 108 configured to pivotally, via pivot bearing 402 connect the front frame and the rear frame. In operation, the pivot bracket 408 allows the ladder legs to settle on an uneven surface due to the motion and degrees of freedom the rear legs have due to the pivot bracket. While the pivot bracket is attached to the back frame and the fixed bracket is attached to the front frame, the reverse may be used as well.

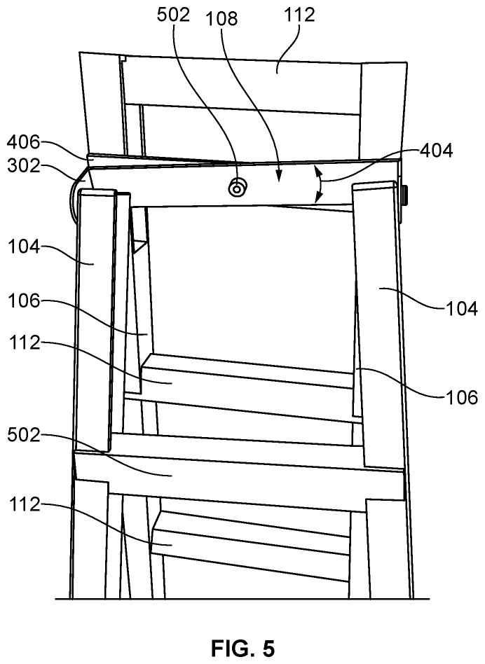

Referring now to FIG. 5, a perspective view of a single point pivot bracket system 108 of the ladder 100, according to one embodiment of the present invention is shown. In one embodiment, the single point pivot bracket system 108 is configured to allow the pair of legs (104 and 106) to move laterally, thereby allowing the front and rear frame and pairs of legs (104 and 106) to independently move relative one another to stabilize the legs and keep them on the ground when placed on an uneven surface. In operation, once the user places the ladder on an uneven surface, the single point pivot bracket system 108 allows the ladder to self-correct using, in some embodiments, nothing more than gravity.

In one embodiment, the single point pivot bracket system 108 further comprises a pivot bracket 404 and a fixed bracket 406. The pivot bracket 404 and the fixed bracket 406 are pivotally connected to at a pivot point. The fixed bracket 404 is configured to pivotally connected to the front frame and rear frame via the pairs of legs (104 and 106) at pivot point or pivot bearing 502 thereby enabling movement independently of one another. In this way, the pair of legs (104 and 106) are pivotally mounted for movement independently of one another using the single point pivot bracket system 108. In embodiments, the pivot bearing may comprise a shoulder bolt. The independent movement of the pair of legs (104 and 106) allows adjustment on surface irregularities, independent of the other set of legs. In some embodiments, the single point pivot bracket system 108 may be adapted to other types of ladders. Back braces 502 connect the back legs for further stability.

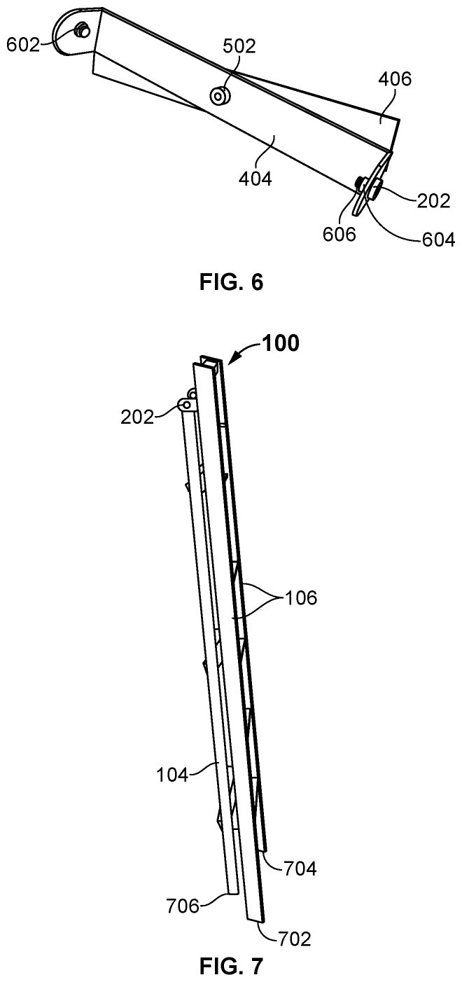

Referring to FIG. 6, a perspective view of the single point pivot bracket system 108 is shown. The pivot bracket 404 and fixed bracket 406 are shown connected at the pivot point or pivot bearing 502. The pivot bracket 404 and the fixed bracket 406 are pivotally connected to at a pivot point. The end cap 302 and 602 are shown with connectors 604 on each side for connecting the bracket to the front frame and rear frame.

Referring now to FIG. 7, perspective view of the pair of legs (104 and 106) of the ladder 100 in a folded position or a locked position, according to one embodiment of the present invention is shown. In one embodiment, both pairs of legs (104 and 106) of the ladder 100 are configured to lock together using a folding bracket system or collapsible bracket system 122, in which the plurality of rungs 112, the brackets (404 and 404), and the set of brackets (124 and 126) of the folding bracket system 122 are nested within the frame and co-planar therewith for storage of the ladder 100.

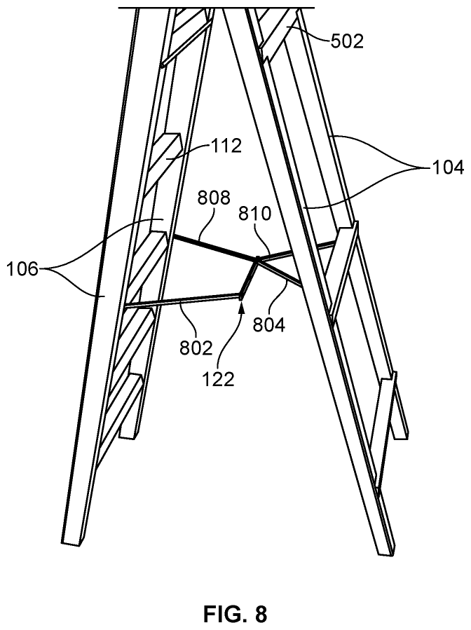

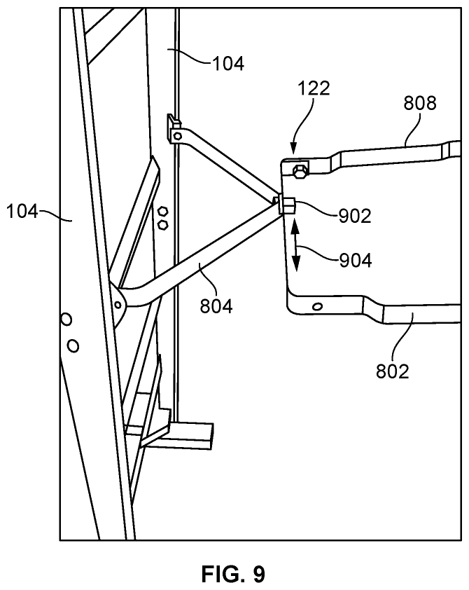

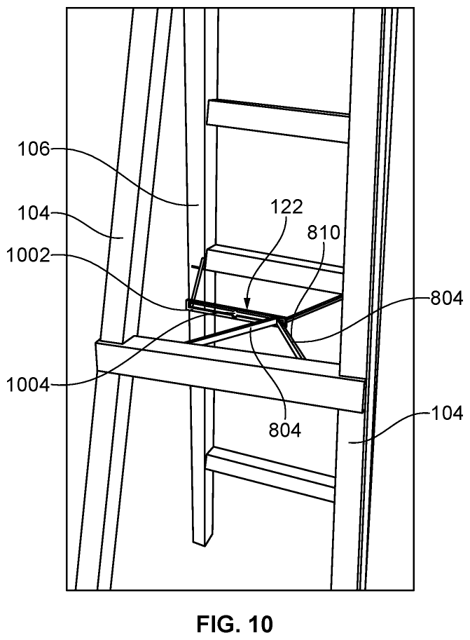

Referring now to FIG. 8, a perspective view of the ladder 100 in an open position or unfold position, according to one embodiment of the present invention is shown. In one embodiment, the ladder 100 further comprises a folding bracket system or collapsible bracket system 122. The folding bracket system 122 comprises right arm 802 and left arm 808 each of which is connected to the front frame at legs 106. A lateral arm 810 is provided and comprises an aperture configured as a slider (discussed in greater detail with reference to FIGS. 9 and 10). A V-bracket 804 is movably attached to the lateral bracket at the slider. The V-bracket 804 is attached to the rear frame at each leg 104. Due to the pivot mechanism and degrees of lateral or rotational motion the pivot bracket system allows, the ladder may not fold into its closing position such that the legs 104 and 106 are flush. The folding bracket system allows the legs to fold flush. In this way, the folding bracket system 122 is configured to keep a correct or optimized angle between the front frame and the rear frame, thereby allowing the rotational movement of both pairs of legs (104 and 106). In one embodiment, the folding bracket system 122 is pivotally and movably affixed to both pairs of legs (104 and 106), respectively, thereby allowing rotational movement for both pairs of legs (104 and 106), independently. In one embodiment, the folding bracket system 122 enables the user to fold the ladder 100 in the closed position, thereby simply storing and transporting the ladder 100.

Referring now to FIG. 9, a perspective view of the folding bracket system 122 of the ladder 100, according to one embodiment of the present invention is shown. In one embodiment, the folding bracket system 122 is configured to enable the ladder 100 to change the position from open to closed position so as to be unfolded or folded when required. In one embodiment, the folding bracket system 122 allows for rotational movement and also collapsible for storage and transport the ladder 100. As can be seen, the folding bracket system 122 comprises right arm 802 and left arm 808 each of which is connected to the front frame at legs 106. The lateral arm 810 is provided and comprises an aperture configured as a slider via a linkage nut 902 so that the arms can slide in the direction of 904 relative to the V-bracket 804.

Referring now to FIG. 10, a back perspective view of the folding bracket system 122 of the ladder 100 according to one embodiment of the present invention is shown. As can be seen, the lateral bracket 810 comprises an aperture 1002 at which the right arm and left arm are coupled to the V-bracket 804. The aperture 1002 acts as a slider mechanism to allow the arms and the bracket to move relative the other. In one embodiment, the folding bracket system 122 may determine the distance between both pairs of legs (104 and 106) and allow to move apart from each other. This keeps the correct angle of both pairs of legs (104 and 106). The folding bracket system 122 is also configured to collapse and allow both pairs of legs (104 and 106) to come together, thereby reducing the space required to move and store the ladder 100. In one embodiment, the folding bracket system 122 could also allow the rotational movement of the independent set of legs (104 and 106).

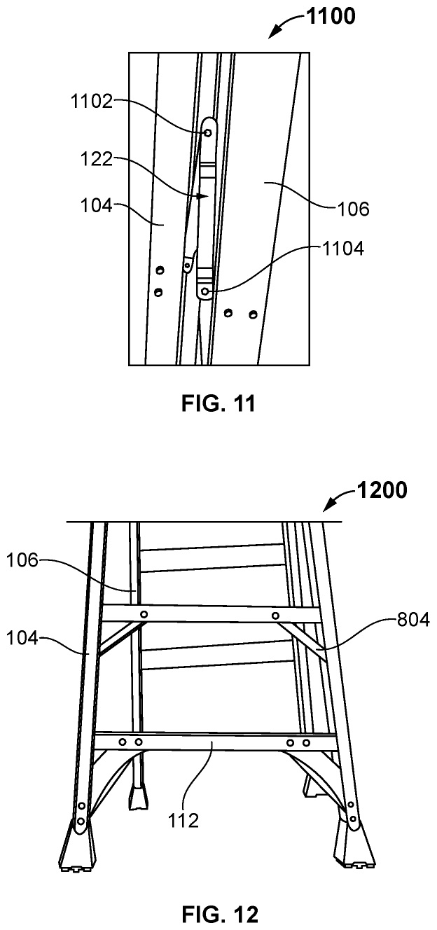

Referring now to FIG. 11, a side view of the folding bracket system 122 is shown in its folded position. In this way, the folding bracket system 122 is configured to enable the user to fold the ladder 100 in the closed position, thereby simply storing and transporting the ladder 100 than when it is in the opened position. Bearings 1102 and 1104 are provides to allow for the folding motion.

Referring to FIG. 12, a perspective view of the pair of legs (104 and 106) of the ladder 100 provided with non-slip feet in its opened position is shown. According to one embodiment of the present invention is shown. In one embodiment, the pair of legs (104 and 106) of the ladder 100 are provided with non-slip feet, thereby preventing the ladder 100 from sliding and/or slipping on various surfaces such as, but not limited to, concrete, asphalt, tiles, carpets, linoleum, and etc. In one embodiment, the non-slip feet are made of, but not limited to, non-slip material and/or rubber.

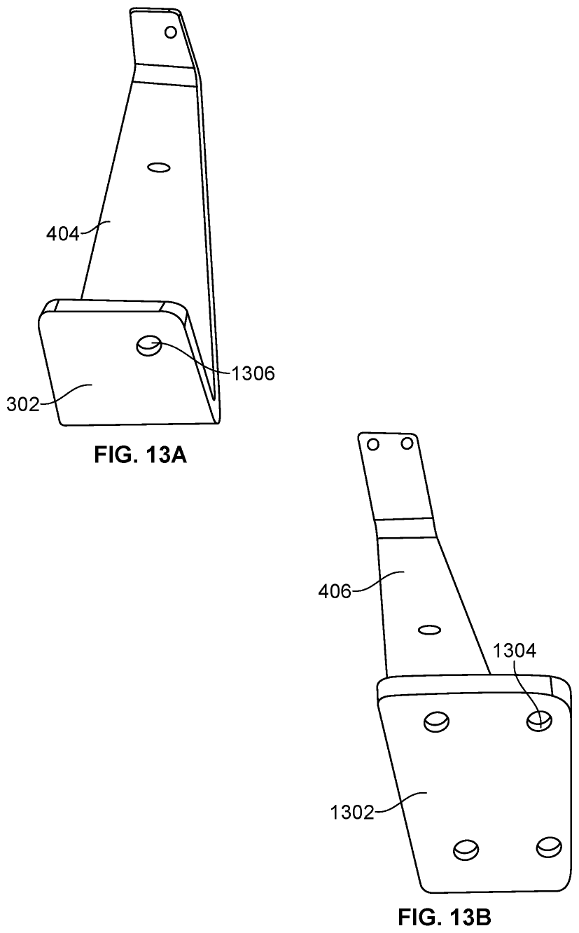

Referring to FIGS. 13A-13B, a perspective view of the rungs are shown according to one embodiment of the present invention is shown. In one embodiment, the plurality of rungs 112 are securely and horizontally affixed to both pairs of legs (104 and 106) using fasteners, for example, bolts and nuts. The plurality of rungs 112 are horizontal support on the ladder 100 for a person's foot and are sufficiently strong to carry the weight of a person or persons using them.

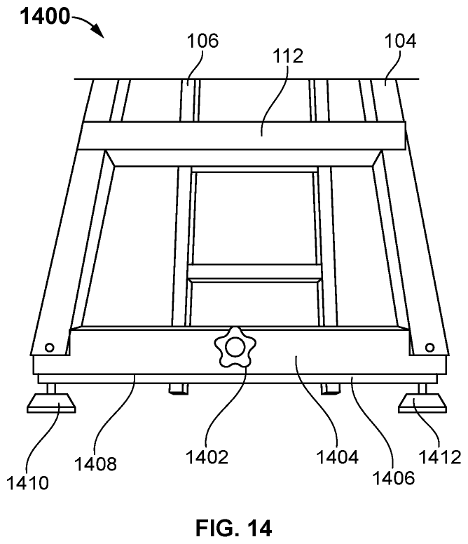

Referring now to FIG. 14, a front view of a modular device 1400 that can be retrofit to an existing ladder is show. The module system 1400 is configured to allow the ladder legs to settle on an uneven surface due to the motion and degrees of freedom the rear legs have due to the pivot bracket 1401 and lets 1406 and 1410 provided thereon. While the pivot bracket is attached to the bottom back frame and the pivot bracket may also be is attached to the front frame. The module system 1400 comprises a front stationary bracket 1404 and has a hollow interior 1408 to allow for mating of an interior pivot bracket 1406. Once the ladder settles on an uneven surface, locking mechanism 1402 may be employed to lock the brackets together and keep the ladder legs in place on the uneven surface. The modular system may be retrofit by being drilled into the bottom portion of the ladder and bolted on or may be retrofit using a clasp. It may also be retrofit via apertures on the top of the device that are dimensioned to fit ordinary ladder legs.

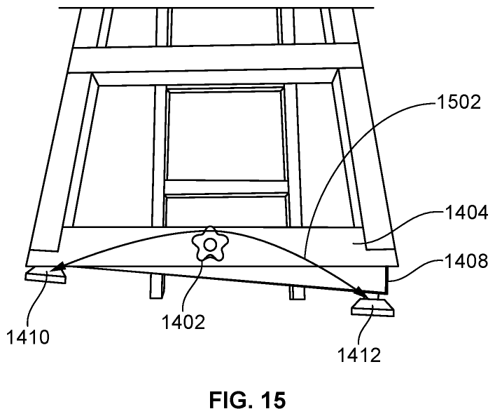

Referring now to FIG. 15, a front view of the modular device of FIG. 14 is shown together with arrow 1502 to show the rotational aspect of the stationary bracket and the pivot bracket 106. As can be seen, the rotation occurs about the pivot pin 1504 integral with the locking mechanism. The pivot bracket is nested in the interior of the stationary bracket.

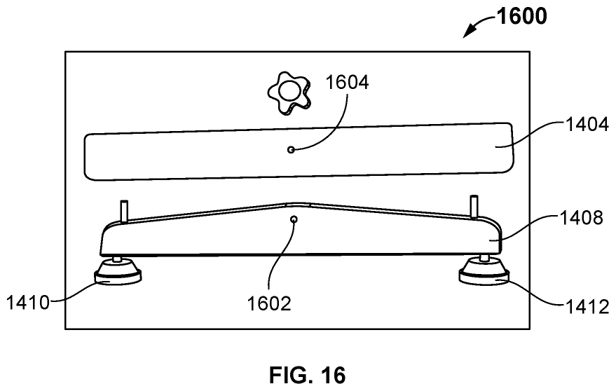

Referring now to FIG. 16, an exploded view of the modular device 1400 that can be retrofit to an existing ladder is show at 1600. The module system 1400 is configured to allow the ladder legs to settle on an uneven surface do to the motion and degrees of freedom the rear legs have due to the pivot bracket 1408 around the pivot pin 1604 with relation to the fixed stationary bracket 1404 inside its hollow interior 1408. Once the ladder settles on an uneven surface, locking mechanism 1402 may be employed to lock the brackets together and keep the ladder legs in place on the uneven surface. The modular system may be retrofit by being drilled into the bottom portion of the ladder and bolted on or may be retrofit using a clasp. It may also be retrofit via apertures on the top of the device that are dimensioned to fit ordinary ladder legs.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A ladder assembly, comprising:
a front frame having a first pair of spatially disposed legs and a plurality of rungs extending between the first pair of legs;
a rear frame having a second pair of spatially disposed legs;
a pivot bracket system coupled to the front and rear frame, wherein the pivot bracket system is configured to allow the legs to shift or pivot, wherein the pivot bracket system comprises:
a pivot bracket attached to one of the front frame or rear frame;
a fixed bracket attached to the other of the front frame or rear frame;
a bearing coupled to the pivot bracket and the fixed bracket, wherein the bearing is configured to provide a pivot point for rotational motion of the pivot bracket and to pivotally connect the front frame and the rear frame;
wherein the pivot bracket system is configured to allow the ladder legs to settle on an uneven surface based on the rotational motion provided by the pivot bracket.

2. The ladder assembly of claim 1, further comprising a folding middle bracket configured to allow the ladder to fold into a storage position.

3. The ladder assembly of claim 1, wherein the pivot bracket is connected to the fixed bracket to form the pivot bracket system, wherein the pivot bracket is configured to pivotally connect the front frame and the rear frame.

4. The ladder assembly of claim 1, wherein the pivot bracket system is coupled to the front frame at a position that is slightly lower than a top of the front frame, and wherein the rear frame is shorter than the front frame, and wherein the pivot bracket system is coupled to the top of the rear frame.

5. The ladder assembly of claim 1, wherein the pivot bracket system comprises a side cap of configured to connect the bracket system to the front and rear frame.

6. The ladder assembly of claim 2, wherein the folding middle bracket comprises;
a right arm connected to the front frame;
a left arm connected to the front frame;
a V-bracket attached to the rear frame at each rear frame leg; and
a lateral arm configured to connect the right arm, left arm and V-bracket.

7. The ladder assembly if claim 6, wherein the lateral arm comprises an aperture configured as a slider, and wherein the V-bracket is movably attached to the lateral bracket at the slider.

8. The ladder assembly of claim 7, wherein the V-bracket connects to the lateral bracket and the slider using a linkage nut, wherein the linkages nut allows the V-bracket to slide laterally to store the ladder in a position in which the legs are flush with each other.

9. A modular ladder leveling device, the device comprising:
a stationary bracket coupled to both legs of a ladder, wherein the stationary bracket has a hollow interior;
an interior pivot bracket nested in the hollow interior of the stationary bracket;
a pivot pin coupled to the stationary bracket and the interior pivot bracket, wherein the pivot pin provides rotational motion about the pivot pin such that when the ladder is placed on an uneven surface the legs settle on the uneven surface;
a lock integral with the stationary bracket and interior pivot bracket, wherein the lock is configured to lock the pivot bracket in place when the ladder legs settle on the surface.

10. The modular ladder leveling device of claim 9, further comprising a clasp to attach the device to the ladder.

11. The modular ladder leveling device of claim 9, further comprising spatially disposed shoes on both sides of the leveling device
